(19) United States
(12) Patent Application Publication
(10) Pub. No.: US 2012/0175288 A1
(43) Pub. Date: Jul. 12, 2012

(54) METHOD AND DEVICE FOR THE SELECTIVE CLASSIFICATION OF PARTICLES ACCORDING TO THE SIZE THEREOF

(75) Inventors: Georg Unland, Freiberg (DE); Thomas Folgner, Oberschona (DE); Martin Steuer, Riesa (DE)

(73) Assignee: Technische Universitat Bergakademie Freiberg, Freiberg (DE)

(21) Appl. No.: 13/384,448

(22) PCT Filed: Jul. 15, 2010
(86) PCT No.: PCT/EP2010/004330

§ 371 Date: Mar. 27, 2012

(30) Foreign Application Priority Data
Jul. 16, 2009 (DE) 09009288.3

(51) Int. Cl. B07B 1/00; B07B 1/46

(52) U.S. Cl. 209/255; 209/233

(57) ABSTRACT

The invention relates to a method and to a device for the selective classification of particles according to the size thereof, determined by a maximum main dimension (a, b, c) of their particle geometric form, by means of classification using passage openings with a three-dimensional classification effect in a screening structure.

### CROSS-REFERENCE TO RELATED APPLICATIONS

This application claims priority to European patent application EP 09009288.3 filed on Jul. 16, 2009 and PCT application PCT/EP2010/004330 filed on Jul. 15, 2010, which are hereby incorporated by reference in their entireties.

### TECHNICAL FIELD

The invention relates to a method and to a device for the selective distinctive classification of particles according to the size thereof.

### BACKGROUND

In materials preparation technology as well as for product manufacture using particles, the use of classified particulate materials is playing an increasingly important role in obtaining a high efficiency level as well as in satisfying quality requirements. Moreover, in many cases the provision of sorted particulate products can make it possible to realise higher quality and price expectations.

For various industrial applications using bulk material consisting of particles of various sizes, the requirements for the quality of the classification, i.e., for the distinct selectivity of the same, differ, whereby different evaluation procedures and evaluation parameters are known for describing the quality of the classification process.

Particularly in the case of very closely fractionated feed materials (particles), in which a large portion of the particles display size differences only in the range of effective separating sizes, the selectivity of conventional classification leaves much to be desired. Also, jamming particles must be expected in the case of conventional, quasi two-dimensional classification devices, which are effective only in the plane and which have screen geometric forms that are only effective in two dimensions, such as round or rectangular hole metal plates or screen meshes without cleaning devices such as brushes or beating balls.

The basis of the invention is formed by the object of stating a method and a device for the classification of particles, whereby this method and device make it possible to increase incisively the quality of the classification, i.e., the selectivity and distinction of the same, substantially when compared to conventional classification methods and devices.

This object is solved according to the method as set forth in of Claim 1 in regard to the method and by the characteristics of the device as set forth in Claim 10 in regard to the device.

A substantial aspect of the present invention consequently consists of the classification of particles according to the size thereof, particularly according to one of their three main dimensions in a Euclidean space (Cartesian coordinate system), particularly the length, width or thickness, whereby the special quality or selectivity of this classification is achieved according to the invention by means of using passage openings with a three-dimensional classification effect in a (three-dimensional) screening structure. Surprisingly, this structure makes it possible to classify with significantly greater selectivity and distinction than previously possible with the conventional two-dimensional screen geometric forms (2D screen geometric forms) mentioned previously.

### SUMMARY

The present invention is based on an innovative generation of three-dimensional screening structures with passage openings with a three-dimensional classification effect, whereby the classification is preferably according to one of the three maximum main dimensions length, width or thickness and the particle dimensions are defined with the help of these main dimensions. In contrast to conventional procedural methods, a size classification in space therefore takes place that leads to a drastic increase in the incisive classification quality and grade.

The classification is preferably carried out in at least a vibrating and/or preferably inclined classification plane, whereby the particles are preferably moved in a projectile or sliding movement along or in connection with a classification plane that preferably has rectangular, e.g., square, and/or elliptical, e.g., circular, passage openings executed in three-dimensions, whereby the particles are preferably also moved along an inclined plane in the area of the three-dimensional passage openings.

It is also possible, however, to use a non-vibrating classification plane. Depending on the classification parameters, in particular one of the screening structure-particle material pairings, a screening structure that is used for the classification has, at least in the area of the passage openings, a predetermined friction coefficient, particularly a predetermined static friction, depending on the main dimension in question.

For a classification of a particle mixture or a particle fraction according to the main dimension length a, preferably the highest possible adhesion coefficient is provided in the area of the passage openings with a three dimensional classification effect, while for a classification according to one of the main dimensions width b or thickness c, the lowest possible friction coefficient, particularly the static friction coefficient, is provided in the area of the passage openings with a three dimensional classification effect, whereby the static friction coefficient of the screening structure is selected in dependence on the particle-lining friction pairing and preferably a classification lining adapted to the particular screening structure, at least in the area of the three-dimensional passage openings, is used.

More preferable is the classification of different fractions according to the same main dimension in a shared device, whereby each classification plane (screen plane) has its own discharge device.

Further preferred embodiments of the method according to the invention are the object of the dependent claims.

The device according to the invention features a classification device with a screening structure with passage openings with a three dimensional classification effect, preferably executed as standing flaps (or standing conduits) that protrude from a base of the classification plane to one side on a particle feed side of the screening structure or on the other hand, as dropping flaps (or dropping conduits) that protrude from a base of the classification plane of the screening structure on the withdrawal side of the screening structure.

Under gravity conditions, the standing flaps or standing conduits are located on an upper side (particle feed side) of the screen structure, while the dropping flaps or dropping conduits are located on a bottom side (particle withdrawal side) of the screen structure.

Preferably the standing flaps arranged on a particle feed side of a screening lining are arranged opposite to a transport direction of the particles along the classification plane for classification according to the main dimension length a of the particles, while standing or dropping flaps that limit the associated three-dimensional standing or dropping conduits of the passage openings are arranged in correspondence with or opposite to a transport direction of the particles along the classification plane if classification is according to a main dimension thickness c of the particles, while for classification according to the main dimension width b, the standing or dropping flaps and the three-dimensional standing or dropping conduits limited by these are preferably arranged in correspondence with a transport direction of the particles along the classification plane. The passage openings can also be arranged so as to be oriented in the direction opposite to the transport direction of the particles.

As a result of the sorting or classification according to the invention, using screen geometric forms with a three dimensional classification effect according to one of the three maximum main dimensions length, width and thickness of the particles, changing the number and position and/or number and/or size of contact areas of the particles in the area of the passage openings achieves a surprisingly high level of selectivity and classification quality, which is particularly of great significance in the case of closely fractionated feed materials, in which case a large portion of the particles lie in the range of an effective separating size and in which a classification process normally has a low level of selectivity.

### BRIEF DESCRIPTION OF THE DRAWINGS

The invention is described in more detail in the following on the basis of embodiments and the associated drawings. Shown are:

FIG. 1 is a schematic depiction of a particle with its maximum main dimensions length a, width b, thickness c,

FIG. 2 is a balance of forces on a particle for describing a particle movement characteristic,

FIG. 3 is a schematic depiction of a movement characteristic of a particle depending on a movement/drive of a classification device for a projectile movement and a sliding movement of the particle,

FIG. 4 is an opening geometric forms of a classification device in an XY plane that corresponds to a base of a classification plane, with circular and square holes as examples of passage openings with equal dimensions in the X and Y directions (left side) and rectangular and elliptical hole geometric forms (passage openings) as examples of unequal dimensions of the passage openings in the X and Y directions on the right side,

FIG. 5 is an opening geometric forms with a three dimensional classification effect in a classification device, with

FIG. 5a is a 3D square hole and

FIG. 5b is a 3D rectangular hole in a design with dropping flap,

FIG. 6 is a three dimensional opening geometric forms of a classification device, with

FIG. 6a is a 3D square hole and

FIG. 6b is a 3D rectangular hole with standing flap, whereby FIGS. 5 and 6 show these opening geometric forms of 3D passage openings in a top view and in a sectional view,

FIG. 7 is a schematic depiction of the action of opening geometric forms according to FIGS. 5a and 6a, with

FIG. 7a is a classification according to the main dimension a with dropping flap and 3D square hole and

FIG. 7b is a classification with standing flap and 3D square hole,

FIG. 8 is a classification according to a main dimension b, with

FIG. 8a is a classification with 3D circular hole with dropping flap and

FIG. 8b is a classification with 3D square hole with standing flap,

FIG. 9 is a classification according to a main dimension c with 3D rectangular hole,

FIG. 9a is with a dropping flap,

FIG. 9b is with a 3D rectangular hole with standing flap,

FIG. 10 is a schematic depiction of a screen deck as a classification device for a classification according to a maximum particle extension, main dimension (length) a,

FIG. 11 is a schematic depiction of a multi-deck device with fractionation for classification according to the maximum main dimension (length) a,

FIG. 12 is a schematic depiction of a screen deck as a classification device for a classification according to the maximum main dimension (length) a with a standing flap in

FIG. 12a is a longitudinal sectional view,

FIG. 12b is a top view,

FIG. 12c is a partial sectional view along the line A-A in FIG. 12b,

FIG. 13 is a schematic depiction of a screen deck as a classification device for a classification according to the maximum main dimension (length) a with coplanar formation of the screen deck and dropping flaps (with passage openings with a three dimensional classification effect) integrated therein in

FIG. 13a is a longitudinal section,

FIG. 13b is a top view,

FIG. 14 is a single-deck classification device for a classification according to the maximum main dimension (length) a in

FIG. 14a is a schematic longitudinal section view,

FIG. 14b is a screen lining of the classification device with 3D square holes in a schematic depiction in a top view,

FIG. 14c is the classification device according to FIG. 14a in a schematic depiction in a side view with discharge device,

FIG. 15 is a multi-deck classification device for a classification according to the maximum main dimension (length) a in

FIG. 15a is a schematic longitudinal section view, whereby

FIG. 15b shows a screen lining of the classification device with 3D square holes in a schematic depiction in a top view, and

FIG. 15c shows the classification device according to FIG. 15a in a side view with discharge device for the different classification devices provided for fractionation,

FIG. 16 is a schematic depiction of a screen deck as a classification device for a classification according to the middle main dimension (width) b with standing flaps,

FIG. 16a in a longitudinal section,

FIG. 16b in a top view,

FIG. 16c in a partial sectional view along a line B-B in FIG. 16b,

FIG. 17 is a schematic depiction of a screen deck as a classification device for a classification according to the middle main dimension (width) b with coplanar formation of the screen deck and the dropping flaps (with passage openings with a three dimensional classification effect) integrated therein,

FIG. 17a in a longitudinal section,

FIG. 17b in a top view,

FIG. 18 is a single-deck classification device for a classification according to the middle main dimension (width) b in

FIG. 18a is a schematic longitudinal section view,

FIG. 18b is a screen lining of the classification device with 3D round holes in the passage plane (circular holes) in a schematic depiction and in a top view,

FIG. 18c is the classification device according to FIG. 18b in a side view in a schematic depiction with discharge device,

FIG. 19 is a multi-deck classification device for a classification according to the middle main dimension (width) b in

FIG. 19a is a schematic longitudinal section view, whereby

FIG. 19b shows a screen lining of the classification device with 3D round holes in the passage plane in a schematic depiction in a top view, and

FIG. 19c shows the classification device according to FIG. 19b in a side view with discharge device,

FIG. 20 is a schematic depiction of a screen deck as a classification device for a classification according to the minimum main dimension (thickness) c with standing flap,

FIG. 20a in a longitudinal section view,

FIG. 20b in a top view,

FIG. 20c in a partial sectional view along the line A-A in FIG. 20b,

FIG. 21a screen deck as a classification device for a classification according to the minimum main dimension (thickness) c with coplanar formation of the screen deck and the standing flaps (with passage openings with a classification effect) integrated therein,

FIG. 21a in a longitudinal section,

FIG. 21b in a top view,

FIG. 21c in a sectional representation along the line C-C according to FIG. 21b,

FIG. 22 is a single-deck classification device for a classification according to the minimum main dimension (thickness) c in

FIG. 22a is a schematic longitudinal section view,

FIG. 22b is a screen lining of the classification device with 3D rectangular holes in a schematic depiction,

FIG. 22c is the classification device according to FIG. 22b in a side view with discharge device in a schematic depiction,

FIG. 23 a multi-deck classification device for a classification according to the minimum main dimension (thickness) c in

FIG. 23a is a schematic longitudinal section view,

FIG. 23b is a screen lining of the classification device with 3D rectangular holes in a schematic depiction,

FIG. 23c is a classification device according to FIG. 23b in a side view with discharge devices in a schematic depiction.

### DETAILED DESCRIPTION

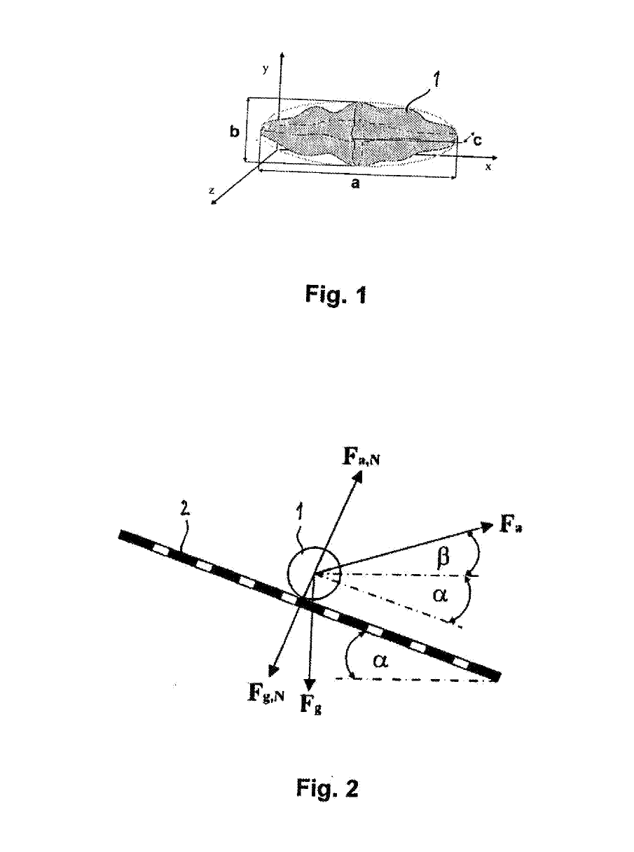

The basis for the following explanations of embodiments of a method and a device for the selective sorting of particles of a feedstock according to the size thereof, based on a classification according to one of the three maximum main dimensions of the same in Euclidean space, is the geometric form of a particle 1, as shown in FIG. 1, whereby this classification of a feedstock, which preferably consists of free-flowing particles and which can be any bulk material, is the main dimensions of the particle, namely its maximum length a, its middle main dimension, the width b, and its minimum main dimension, the thickness c, whereby these three main dimensions of the particle 1 defined in the Cartesian coordinate system can be depicted in the main axes X, Y, and Z by a smooth body, such as a cuboid or, as indicated in FIG. 1, by an ellipsoid as the envelope, as is shown in FIG. 1. In the present embodiment, an ellipsoid with the main dimensions length a, width b and thickness c is used, whereby the volume of this enveloping ellipsoid is minimum. The relationship of the three main dimensions (length a, width b, thickness c) can be described with a>b>c, whereby a is perpendicular to b, b is perpendicular to v and v is perpendicular to a.

On the basis of a precise definition of the dimensions of a particle 1 in the three spatial planes XZ, ZY and XY, the task of a classification of high quality can be defined in three cases, each according to one of the three main dimensions. Particularly in the case of very closely fractionated feed materials in which a large portion of the particles 1 lie, with respect to their size, in the range of the effective separating size, the 3D classification proposed here, which is to be understood as a classification using passage openings with a three dimensional classification effect, achieves a surprisingly high-quality and selective classification, whereby a clear reduction in jamming particles is also achieved without the use of special cleaning devices. The enveloping ellipsoid in FIG. 1 used for the definition of the particle geometric form has a defined dimensional relationship of a:b:c=6:2:1.

In the case of a three-dimensional, which means carried out using passage openings with a three dimensional classification effect, highly selective size classification of particles according to a main dimension of the same (in the framework of this application also referred to as “3D classification”), it is useful, both for setting up a model in terms of the physical method and for defining the different solution variants, to select suitable descriptive elements with the help of which the function of 3D classification geometric forms (classification lining, screen structures) can be described. Serving as parameters here are a particle movement, a screen opening geometric form, i.e., a geometric form of passage openings, which have a three-dimensional classification effect, in the screen device with their characteristic dimensions as well as the relevant friction characteristics that prevail or that are to be defined depending on the classification task.

The particle movement is thereby described with the help of an index, which is described by the ratio of the components of an acceleration force Fₐ and the weight F_{g} acting on a particle 1 and standing perpendicular to a classification plane of a classification device (screen device). This index is called the screen or projectile index S_{V}. FIG. 2 shows the balance of forces acting on a particle 1 during the particle acceleration due to linear vibration for describing/determining possible movement events for a screen device (classification device 2). The screen index is calculated as follows:

$${S}_{v} = \frac{{F}_{a , N}}{{F}_{g , N}}$$

$${S}_{v} = \frac{{F}_{a} \cdot sin ( α + β )}{{F}_{g} \cdot cos ( α )}$$

$$mit \text{:} {F}_{a} = {m}_{p} \cdot a$$

$$mit \text{:} {F}_{g} = {m}_{p} \cdot g$$

$${S}_{v} = \frac{α \cdot sin ( α + β )}{g \cdot cos ( α )}$$

In this case, mₚ designates a particle mass, α a set angle of a screen plane (classification plane) or of a classification lining of the screen or classification device 2, and β a working angle of the acceleration force as a result of the vibratory impetus of the screen or classification device 2.

To describe a particle movement along the classification device or screen device 2 (=movement along a classification lining), a distinction is made between a projectile movement when Sᵥ>1 and a sliding movement when Sᵥ<1.

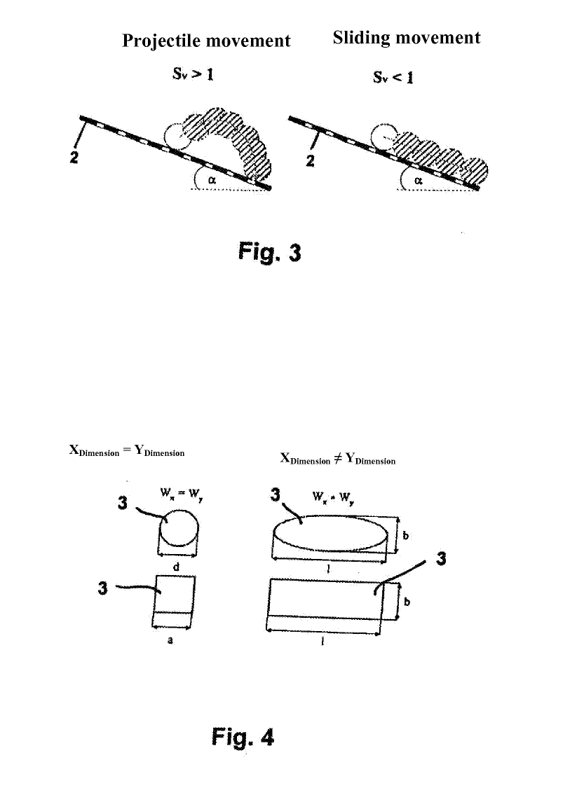

In FIG. 3, the movement conditions of a round model body are shown during a projectile or sliding movement using an inclined classification lining (classification device 2) as an example.

Used as a sorting device or means for classification of particles 1 are preferably vibrating screens (screen devices 2 with a vibratory drive) or a screen device 2 that, when placed in an inclined position, causes, due to this inclination, a sliding movement of the particles 1 along the screen device 2 in the classification plane when the screen device 2 is at rest, as is shown schematically in FIG. 3. The screen device 2 can preferably have circular vibration, elliptical vibration, linear vibration or planar vibration.

Preferably a 3D square hole, 3D longitudinal hole, 3D rectangular hole, 3D elliptical hole or 3D circular hole is provided as the screen opening geometric form, which describes the geometric form of the passage openings 3 with a three dimensional classification effect in a classification or screen lining 2. The screen opening geometric form accordingly describes the geometric form of the passage openings 3 of the screen or classification lining 2 (that forms the classification device). In principle, the opening geometric forms can differ hereby in an XY plane and in an XZ plane or in a Y/Z plane. In an XY plane that forms a classification plane and that extends horizontally in a main plane of the classification device (screen lining 2), a distinction can be made between screen opening geometric forms in which a dimension is of equal size in the X and Y directions and screen opening geometric forms in which these dimensions differ from each other. The first is depicted in FIG. 4 on the left side for a circular or a quadratic passage opening 3, while two examples for different dimensions of the passage openings 3 in the X direction and the Y direction are shown on the right side of FIG. 4 as rectangular or elliptical passage openings.

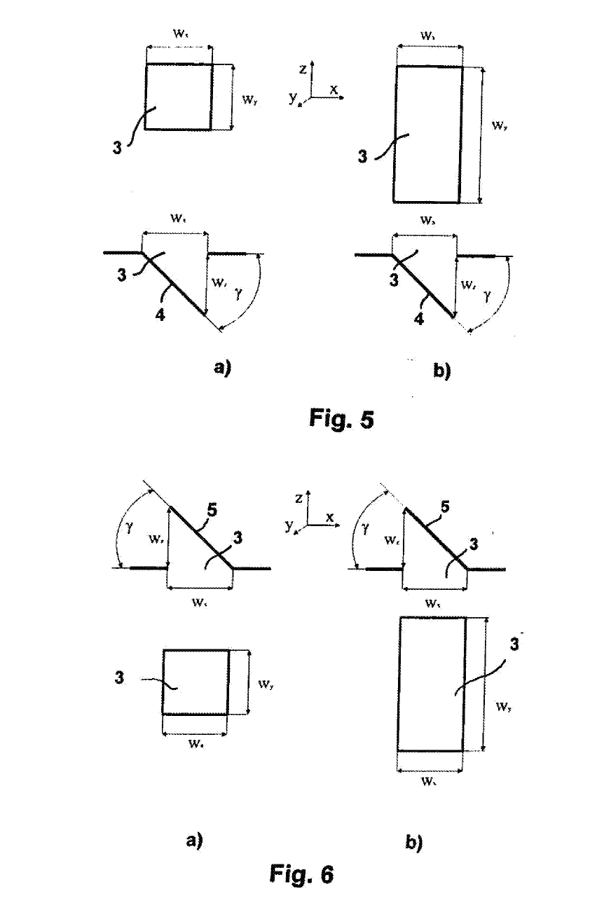

For forming a three-dimensional passage opening 3 with a classification effect, preferably one of the previously described “two-dimensional” opening geometric forms in the XY plane is given a tilted plane in the XY or YZ plane, whereby this tilted plane is arranged along one of the spatial axes X or Y at a defined angle y to the plane XY. In this way, there results a vertical opening between the XY plane and the tilted plane, whereby this vertical opening has the dimensions w_{X}−w_{z} or w_{y}−w_{z}, whereby variants of a 3D geometric form for creating the passage openings 3 are shown in FIG. 5 and FIG. 6 when a square or rectangular opening geometric form is selected in the XY plane. The tilted plane can be executed as a dropping flap 4 as shown in FIG. 5 or as a standing flap 5, as shown in FIG. 6. FIG. 6a shows thereby a 3D square hole as the passage opening 3 while FIG. 6b shows a 3D rectangular hole with standing flap 5.

The method of action of the 3D size classification for a selective classification according to the maximum main dimensions a (length), b (width) and c (thickness) by using a defined opening geometric form of the passage openings 3, which is aligned in the three spatial planes XY, YZ and ZX, as well as by a selection of the particle movement described above and taking into account the friction conditions depending on the respective classification task (different friction conditions depending on the classification according to the main dimension length a or main dimension width b or main dimension thickness c) achieves a classification according to one of the three particle dimensions length a, width b or thickness c. This is explained in detail in the following using associated embodiments.

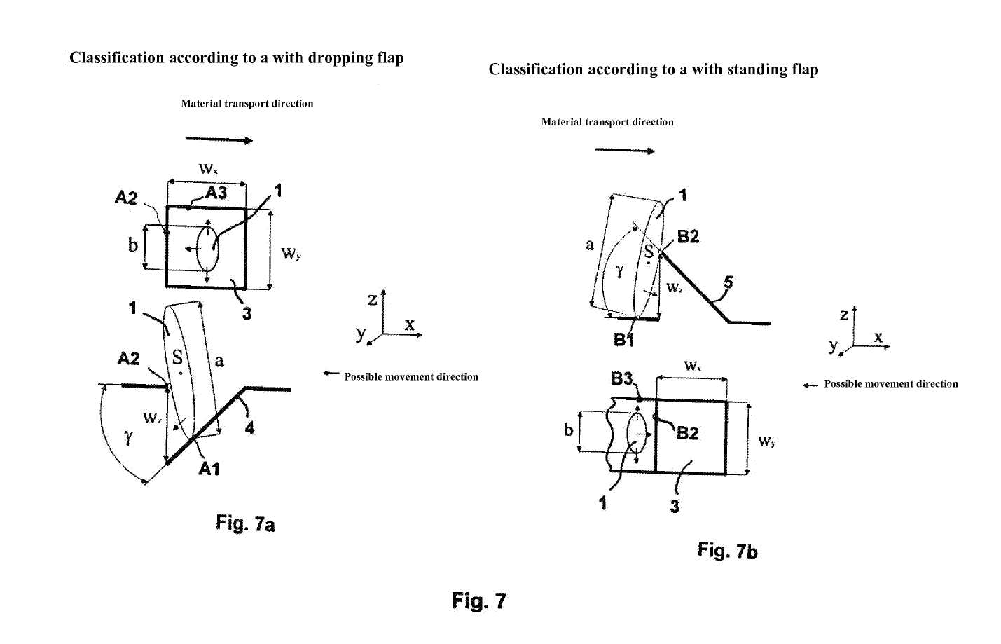

FIG. 7 shows the classification according to the main dimension length a, once for the case when passage openings 3 with a three dimensional classification effect are used with a dropping flap 4 in FIG. 7a and once for the execution of passage openings 3 with a standing flap 5 in FIG. 7b, in each case shown schematically in a sectional view and top view. The classification according to the main dimension length a is explained taking as an example a square opening geometric form, i.e., with a quadratic passage opening 3 in the XY plane, a screen index S_{V}>1 (projectile movement) and a dropping flap 4 or standing flap 5 directed opposite to the material transport direction. FIG. 7 shows an example for the use of a dropping flap 4 and an example for a standing flap 5 for the classification according to the main dimension length a by means of a 3D square hole. If, when using the design of a classification device (screen lining) with a dropping flap geometric form, i.e., when using a dropping flap 4 that tilts downwards from a base of the classification plane as shown in FIG. 7a, a particle 1 is activated into a projectile movement by the selection of the screen index, the result is, as shown in FIG. 7a, an “insertion” or “standing up” of the particle 1 with its width b due to an effective classification geometric form wₓ−w_{y} of the 3D square hole passage opening 3. Due to the alignment of the dropping flap 4 opposite to the material transport direction of the particles 1, the particle 1 is held in its alignment when it is “inserted” in the XY plane. When the particle 1 strikes the dropping flap 4, the particle 1 tips and is held by at least three points A1, A2, A3 (see FIG. 7a). The arrows of a possible movement direction in FIG. 7 indicate a possible movement direction of the particle 1.

It is important here that the selection of the material of the classification liner or screen liner of the classification device combined with the consideration of the type of particle 1 to be classified and the elements of the friction pairing formed by this provides a high static friction coefficient of the particle-screen lining friction pairing of the classification device. Preferably high static friction coefficients are needed for the friction conditions in the case of classification according to the maximum main dimension length a; in the framework of the present patent application, this means preferably a static friction coefficient of μ≧0.3, particularly μ≧0.7.

Due to the friction, it is thereby ensured that the particle 1 is held for classification according to the maximum main dimension length a in the standing position shown at the bottom of FIG. 1a due to the contact at the points A1, A2 and/or A3, and therefore that it remains on the screen lining or on the classification device and does not slide through the passage 3 (as do the other particles that do not have a predetermined length a defined by the development of the screen lining depending on the feedstock and consequently pass through the passage 3).

Due to the movement of the classification lining or of the classification device (screen deck 11), it is guaranteed that the particle 1 is held in its defined alignment and can consequently be classified according to the length a depending on a position of its centre of gravity S. Without an adequately high static friction coefficient, the particle 1 would, as shown in FIG. 7a, tip and not be held by the contact point A1 in contact with the dropping flap 4 and could, with its width, slide through the passage opening resulting between the XY plane and the dropping flap 4.

An analogous design, but with the use of a standing flap 5 (naturally the classification device or the screen lining has a multiplicity of such standing flaps 5 or, in the case of the execution according to FIG. 7a, dropping flaps 4) is shown in FIG. 7b, whereby it is also possible to classify according to the maximum main dimension length a with such a standing flap 5 that protrudes upwards from a base B of the classification plane. If, when the 3D standing flap geometric form with a classification effect according to FIG. 7b is used, a particle 1 is activated to a projectile movement due to the selection of the screen index, the result, as shown in FIG. 7, is a standing of the particle 1 with its width b parallel to the XY plane. Due to the alignment of the standing flap 5 opposite to the material transport direction, the particle 1 is held in its alignment when it “stands” on the XY plane. Here again, the particle 1 tips when it strikes the XY plane and is held by at least three points B1, B2, B3. Also hereby the selection of the material of the classification lining or of the screen lining and the classification device must guarantee that a high static friction coefficient t is present for the friction pairing particle-classification lining or the surface lining of the classification device (μ≧0.3). Preferably a friction coefficient of μ≧0.7 is provided. During the movement of the classification lining it is consequently guaranteed that the particle 1 is held in its defined alignment and standing position and can consequently be classified according to the length a depending on the position of its centre of gravity S. Here again, without an adequately high static friction coefficient, the particle 1 would tip and, with its width, slide through the passage opening 3 that results between the XY plane and the standing flap 5.

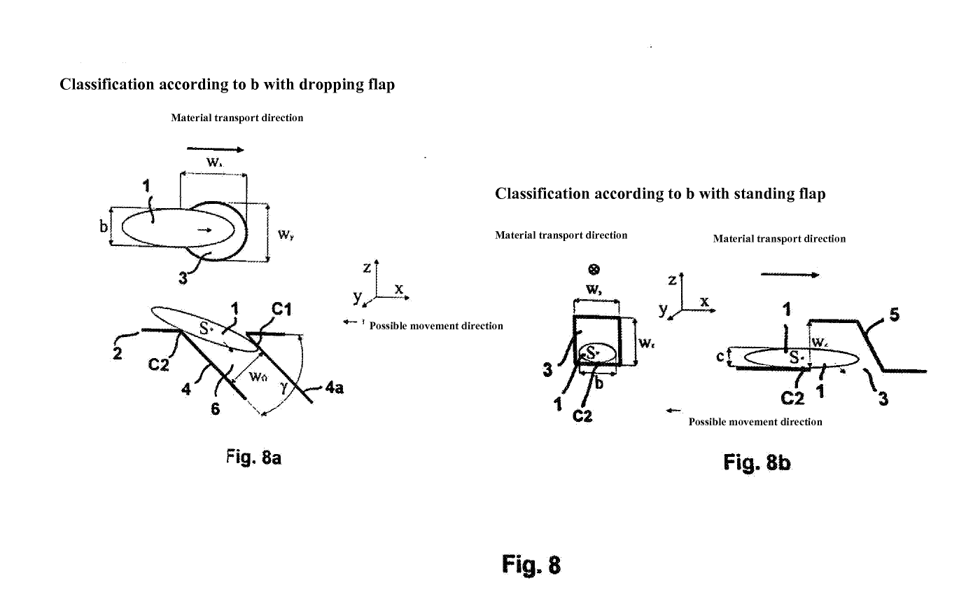

In the following, the classification according to the main dimension width b is explained using FIG. 8a and FIG. 8b, in each case again for the execution of the classification lining or of the classification device with a dropping flap 4 (FIG. 8a) and standing flap 5 (FIG. 8b). When a circular, i.e., elliptical in the XY plane, passage opening 3, a screen index S_{V}<1 (sliding movement) as well as a dropping flap 4 opened in the material transport direction are used, the particles 1 can be classified according to their width b. If, due to the selection of the screen index (S_{V}<1), a particle 1 is activated to a sliding movement, the result, as shown in FIG. 8a, is, due to the position of the centre of gravity S of the particle, a “falling through” of the particle into a circular passage conduit 6, which is formed by the dropping flap 4 as well as preferably a dropping flap 4a extending in a parallel direction from an opposite edge of the passage opening 3 (the dropping flaps 4, 4a can be an integral tube for forming the passage conduit 6). Classification according to the particle width b takes place in this passage conduit with the circular cross-section and an opening diameter of w_{δ}. The particle 1 that is to be classified falls, with its main dimension a (length), into the passage conduit 6 and touches this passage conduit 6 in at least one point C1, while it simultaneously is in contact with the edge of the passage opening 3 at a further point C2. In this case, a static friction coefficient μ that is as low as possible must be selected for the friction pairing particle-classification device by selecting the material for the classification device or of the classification lining 2, along which the particle 1 moves, in particular with a static friction coefficient μ≦0.3, so that the particle 1 is prevented from getting stuck in the passage conduit 6. For classification according to the width b, it is consequently necessary to provide a selection of the friction coefficient for the friction pairing between the particle and the classification device or the screen deck or classification lining that is just the opposite of the classification according to the main dimension length a, and to select or set up the same depending on the type of particle 1 to be classified or the material of the classification device, i.e., the surface of the classification lining 2, along which the particles 1 move. Particles that do not have this width b defined as a classification criterion (particles with larger widths) remain on the screen lining.

FIG. 8b illustrates schematically a classification according to the main dimension width b with the use of a square opening geometric form in the XY plane (3D square hole), a screen index S_{V}<1 (sliding movement) and a standing flap 5 that opens towards the material transport direction, by means of which it is likewise possible to classify according to the width b. In this case, if a particle 1 is activated to a sliding movement along the classification device due to the selection of the screen index S_{V}<1, the particle 1, as shown in FIG. 8b, slides in the XY plane towards the square passage opening 3 (3D square hole) of the standing flap geometric form and comes into contact with this in at least one point C2. Depending on the position of the centre of gravity S of the particle 1, the particle 1 turns, due to the moment acting on the particle 1, into the opening geometric form of the passage opening 3 with the standing flap 5 in the XY plane or moves around this. Through the selection of the material of the classification device or of the screen lining, it must preferably be ensured in coordination with the material of the particles 1 that the friction pairing particle-classification lining or classification device has the lowest possible static friction coefficient, so that the particle 1 is prevented from getting stuck in the opening geometric form of the 3D passage opening 3 with the standing flap 5. Here again preferably a static friction coefficient μ≦0.3 is selected.

Here again the arrows in the depictions indicate a possible movement direction of the particle 1.

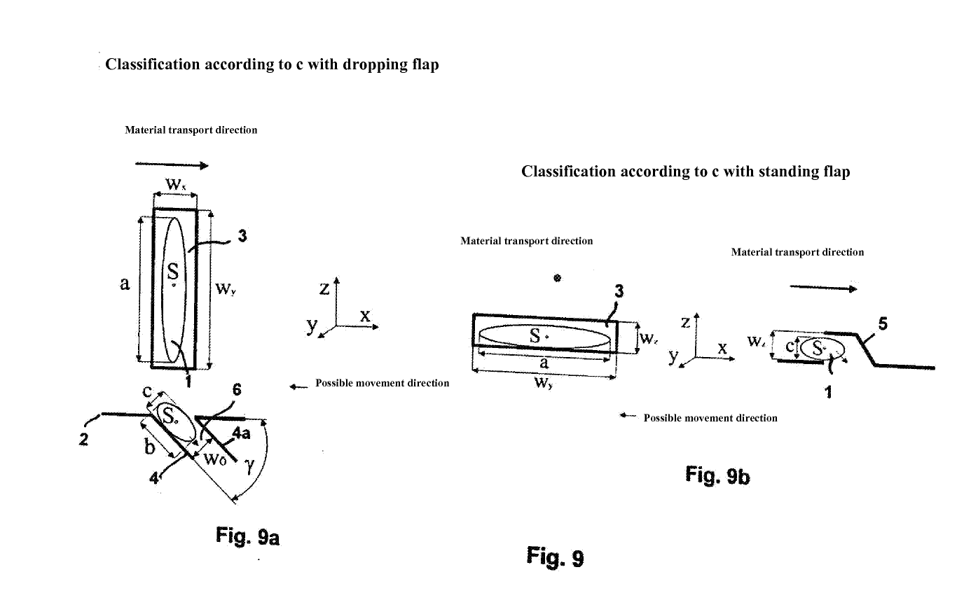

In the following, FIG. 9 is used to explain a classification according to the main dimension c (thickness), likewise using both an execution of the classification device with dropping flap 4 (FIG. 9a) and an execution with standing flap 5 (FIG. 9b). Preferably it is possible to classify according to the main dimension thickness c of the particle 1 using a rectangular opening geometric form (passage opening 3) in the XY plane, a screen index S_{V}<1 (sliding movement) and a dropping flap 4 opened in the material transport direction. The 3D rectangular opening is arranged with its long side preferably at a right angle to the material transport direction, as is shown in FIG. 9a. If a particle 1 is activated to a sliding movement due to the selection of the screen index (S_{V}<1), the result is, as shown in FIG. 9a, an alignment of the particle 1 with its main dimension a (length) along the longest dimension of the rectangular opening geometric form (3D rectangular hole in the XY plane). As a result of this alignment, the particle 1 slides with its B/C plane into a rectangular opening conduit 6 between the dropping flap 4 (as well as a parallel dropping flap 4a lying opposite, which extends from the opposite edge of the passage opening 3) and the XY plane. Due to the dimension (width w_{δ} of the opening conduit 6, which is defined by the minimum distance between the dropping flap 4 and the XY plane), the classification according to the particle thickness c takes place in the opening conduit 6. As with the classification according to the main dimension b (width), here again the selection of the static friction coefficient of the friction pairing particle-classification lining or screen deck material or the surface of the classification device must be executed so that it is as low as possible (in particular, μ≦0.3), so that the particle 1 is prevented from getting stuck in the passage conduit 6.

The calculation of the hole thickness w_{z} (FIG. 9a) or the hole diameter wₓ (FIG. 8a, also refer to FIGS. 4 to 9) is done using w_{z}=wₓ·tan α.

FIG. 9b illustrates schematically the execution of a classification device for classification according to the main dimension thickness c by means of a standing flap 5 using a rectangular opening geometric form in the XZ plane, a screen index S_{V}<1 (sliding movement) as well as a standing flap opened opposite to the material transport direction. Here again, the rectangular opening geometric form (3D rectangular hole) is arranged with its long side at a right angle to the material transport direction. If a particle 1 is activated to a sliding movement due to the selection of the screen index (S_{V}<1), the result is, as shown in FIG. 9b, an alignment of the particle 1 with its main dimension length a along the longest dimension of the rectangular opening geometric form of the standing flap 5 in the XY plane. There, due to the dimension w_{z} that is defined by the minimum distance between the standing flap 5 and the XY plane, the classification according to the particle thickness c takes place. Here again the selection of the material of the screen lining or of the classification device must guarantee that the smallest possible static friction coefficient of the friction pairing particle-classification or screen lining is selected so that the particle 1 is prevented from “getting stuck” in the passage conduit 6. Here again, an arrow indicates a possible movement direction of the particle 1. The static friction coefficient preferably has a value μ≦0.3. The particles that do not correspond to the measurement of the defined thickness c as a classification criterion (the thicker particles) remain on the classification lining.

On the basis of the preselected embodiments, it is possible to implement a selective classification of particles 1 according to their size on the basis of the three particle main dimensions length, width and thickness with the help of a three-dimensional classification geometric form, i.e., passage openings 3 with a three dimensional classification effect.

Taking into consideration the dimension relationships of the passage openings 3 in the X and Y directions, a particle movement (screen index), an opening geometric form of the 3D passage openings with a classification effect, an opening geometric form of the passage openings in the XY plane or YZ plane, an opening geometric form in the XZ or YZ plane as well as the fundamental static friction levels of the friction pairing particle-material of the screen structure (classification device) depending on the classification task, a multiplicity of execution possibilities (at least six or more) for classification according to the particle length a or the particle width b or the particle thickness c of the particle 1 are provided as possibilities for a procedural implementation of the method according to the invention taking into account the aforementioned parameters.

In the following, procedural models and devices for implementing the previously explained size classification of particles according to one of their main dimensions length, width or thickness are explained schematically.

FIG. 10 schematically shows, on the basis of a single-deck screen 7, a fundamental device implementation for a classification device with a single-deck screen 7 for a classification according to the main dimension a. Without it being shown in detail, here, as explained on the basis of FIG. 7a (bottom left), there is an explanation of a passage of the fed particle material through the single-deck screen 7 as far as the particles do not have a length a that would lead to the particles 1 remaining on the single-deck screen 7 and consequently to a classification according to the main dimension length a, as is shown in FIG. 7a.

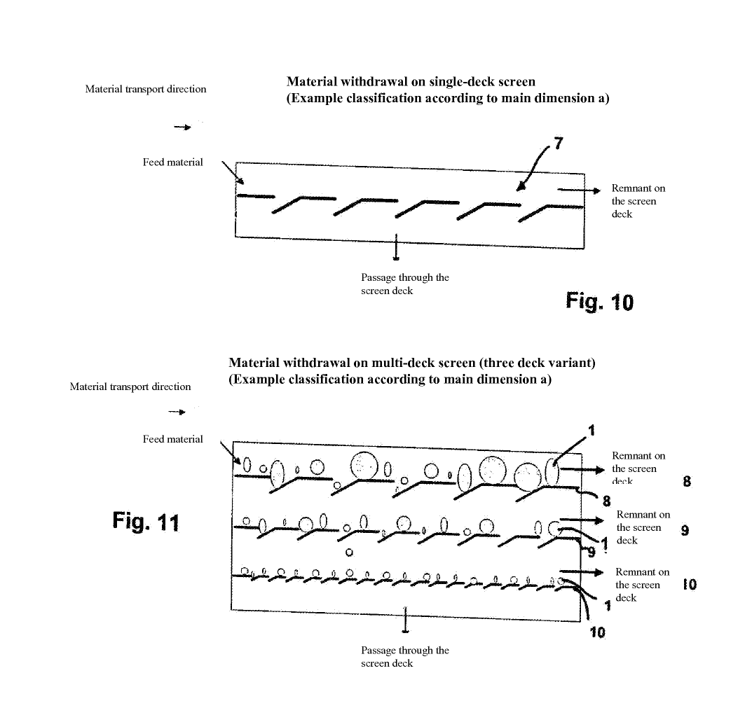

Naturally it is possible, with the help of a multi-deck screen device shown here schematically in a sectional view with three screen decks 8 to 10 in FIG. 11, to carry out or obtain a fractionation, i.e., different fractions of the particles 1 classified according to the same main dimension length a, whereby after a feed of bulk material or other material of particles 1 on the left side of the upper screen deck 8, those particles that, due to the dimension of the passage openings and their similar length a remain as the largest particles (with regard to the length a) on the upper screen deck 8, while the two further screen decks 9 and 10 are used for respective classification of smaller particles according to their maximum length a, each in a corresponding manner.

In this way, three fractions of particles 1 are obtained, all of which are classified according to the maximum length a. Each screen deck 8 to 10 thereby stipulates a predetermined size of the maximum length a and consequently determines the result of the fractionation and size classification into coarse, medium and fine goods.

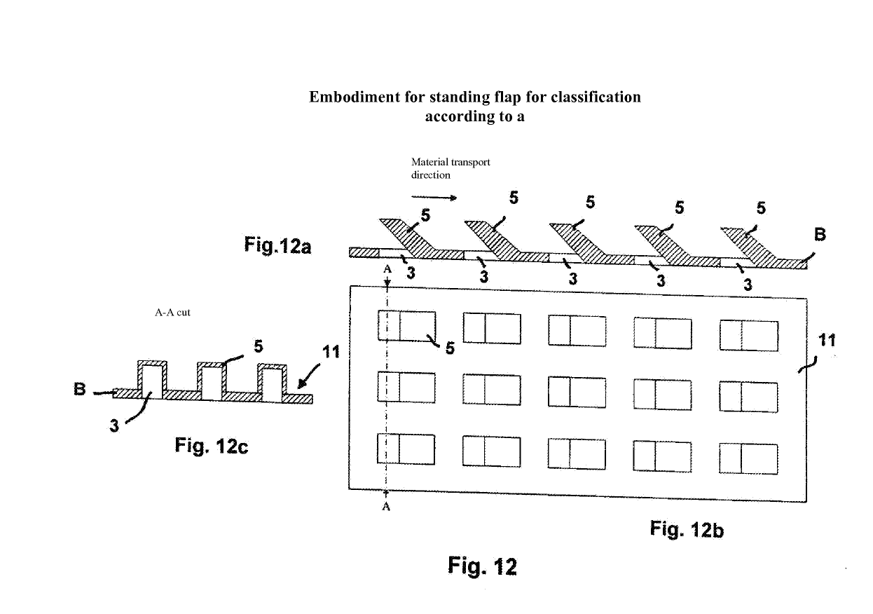

FIG. 12 shows a schematic depiction of a screen deck 11 as a classification device for a classification likewise according to the main dimension length a, whereby a screen deck 11 of this kind can be made, e.g., from polyurethane, so that the standing flaps 5 are formed, not, e.g., by being bent out from a base B of the classification plane or classification device for creating the passage openings 3, but instead, for example, by a separate injection moulding of synthetic resin or plastic, and also protrude beyond the passage openings 3 in their width, as follows from FIG. 12c (a sectional view along the line A-A) in the top view of the screen deck 11 according to FIG. 12b. Other materials, such as wood or ceramic (cast) can also be used for the screen deck in adaptation to the material of the particulate material to be classified. A base of the classification device formed in this way is identified with B, and the standing flaps 5 rise up out of this or from this. FIG. 12c shows a sectional view of the screen deck 11 in a schematic depiction, as already explained in connection with FIG. 12a (longitudinal section).

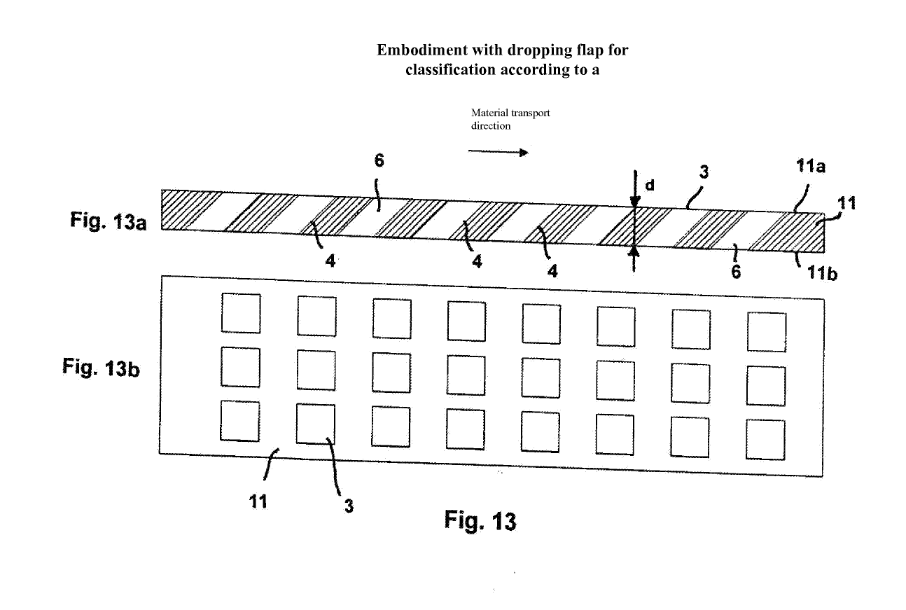

FIG. 13 illustrates a further embodiment of the device arrangement or implementation for a classification of particles 1 according to their main dimension length a in a schematic depiction.

In this case, a thickness d of the screen deck 11 or of the classification device is chosen to be so big that the passage opening develops a three-dimensional classification effect and in the framework of a material thickness (d) of the screen lining 11, the dropping flaps 4 are formed practically inside of and integral to the screen deck, so that the corresponding opening conduits 6 of the 3D openings with the classification effect (in this case, 3D square holes) are formed within the thickness of the screen deck 11 and this screen deck has a coplanar configuration from which no projections whatsoever protrude. Naturally such a classification device can likewise be manufactured very advantageously by means of injection moulding or another casting forming method, or, if made of metal, by means of corresponding diagonal stamped holes made by milling. It would also be conceivable first to introduce the passage openings 3 vertically in a metal element as the screen deck 11 and then to form this by means of tensile forces acting in opposing directions in an area of an upper or lower deck area 11a, 11b, in a manner similar to the manufacture of expanded metal grids, so that a corresponding inclined arrangement of the opening conduits 6 is achieved. The behaviour of the passage openings 3, i.e., of the 3D square holes or of the dropping flaps 4 (walls of the opening conduits 6) formed by the screen deck 11 itself corresponds, in the case that there is adequate thickness d of the screen deck 11 with respect to a particle centre of gravity point S and consequently in regard to an effective separating size regarding the main dimension length a, completely to that according to FIG. 7a, so that selective classification is also allowed in the embodiment according to FIG. 13 for a classification according to the maximum main dimension length a by means of such a classification device with coplanar upper and lower sides 11a, 11b and dropping flaps 4 inclined against the material transport direction for forming the opening conduits 6 as integral, inclined passage openings of the classification device or of the screen deck 11.

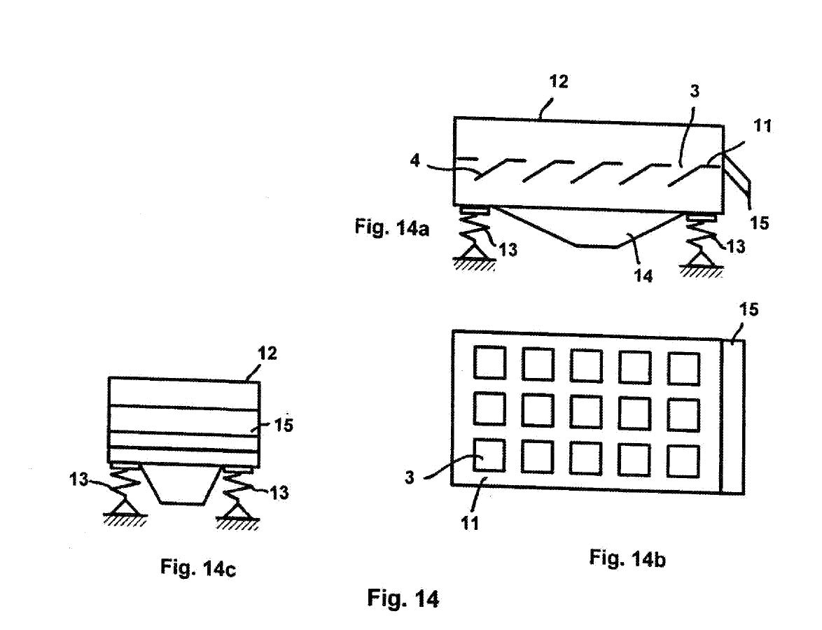

FIG. 14 shows a device implementation of a classification according to the main dimension length a with a screen deck 11, that is arranged within a housing 12, that is spring-loaded by means of supporting springs 13, whereby here 3D square holes are provided as passage openings 3. A discharge funnel 14 (also called an undersize discharge unit) schematically indicated in FIG. 14a is used for collecting particulate material that does not correspond to the classification condition main dimension length a and that has gone through the passage openings 3 of the screen deck in combination with the dropping flaps 4 through the classification plane formed by the screen deck 11. The particle material classified according to the length a as the main dimension remains lying on the screen deck 11 (as shown in FIGS. 7a and 11) and is taken away by means of a discharge chute 15.

In the schematic side view according to FIG. 14c, the discharge chute 15 is shown extending across the entire width of the housing 12 of the classification machine, but this does not mandatorily have to be provided in this manner.

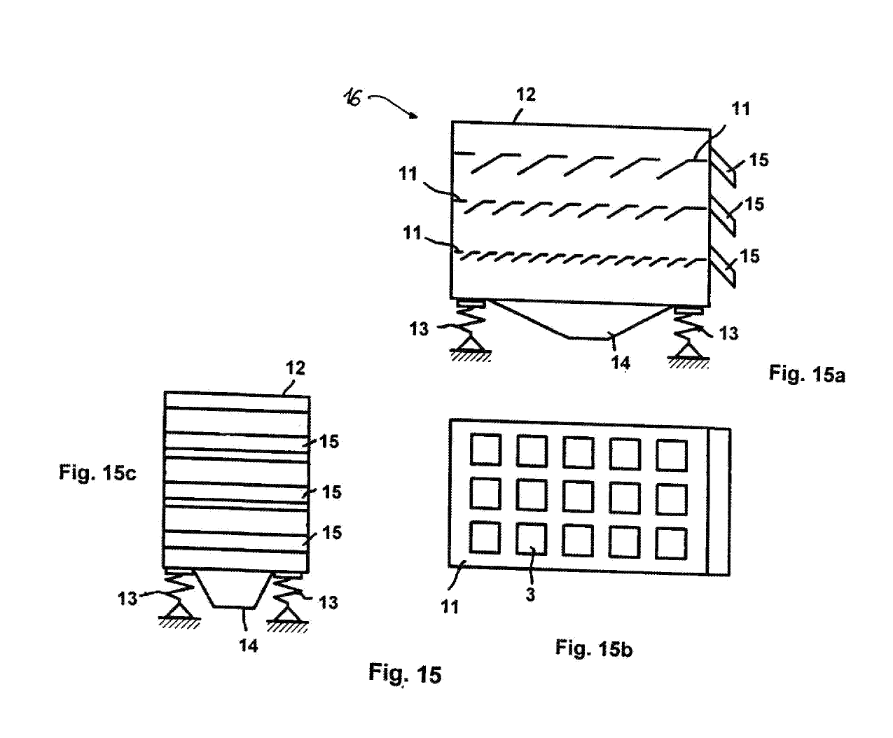

FIG. 15 shows a sorting machine 16 as a multi-deck machine with three screen decks 11, each for a classification according to main dimension a (length), but for different fractions (size classes of a) corresponding to the explanation in the schematic depiction according to FIG. 11 which is correspondingly referenced. In this way, a plurality of fractions of particle material, which is fed out on the upper screen deck 11 and which is classified according to the length a, can be produced and withdrawn to the side, separated by appropriate discharge chutes 15. Again, the undersize discharge unit or the discharge funnel 14 is used for collecting the particle material that does not correspond to the “fractionated” classification condition length a. Here again, the hole geometric forms (passage openings 3) with a classification effect are executed as 3D square holes.

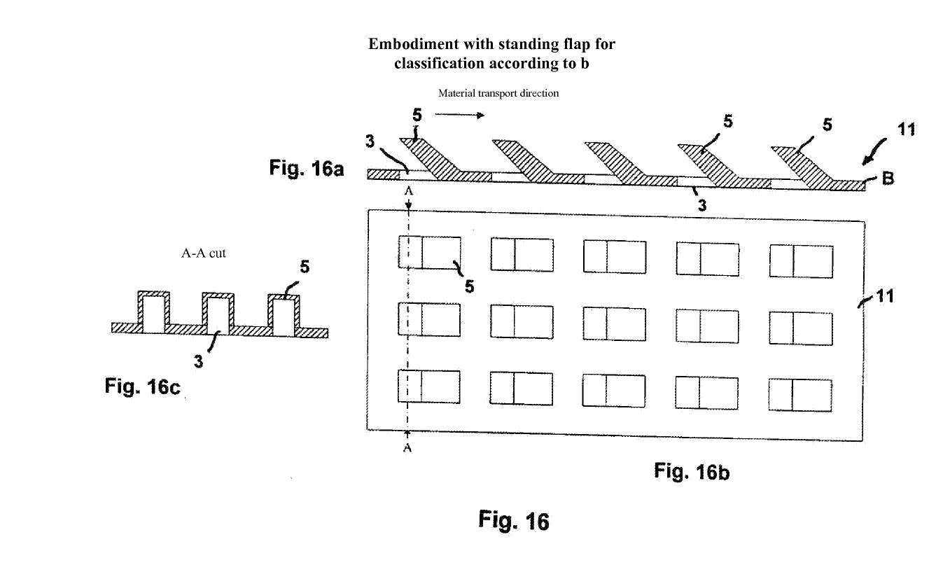

In a schematic depiction, FIG. 16 illustrates a device embodiment for a classification according to the particle width b as a main dimension, using standing flaps 5, which is comparable to the embodiment for a classification according to the dimension a with standing flaps according to FIG. 12. Reference is made to the above explanations in combination with the preceding figures, particularly to FIG. 8b, with regard to the mode of action. The determination of the dimension w_{y}, which defines the minimum opening width of the standing flap 5 in the YZ plane, here determines the classification according to the particle width b. It is essential here that the smallest possible friction coefficient be selected in the friction pairing particle-screen deck 11 (μ≦0.3, static friction coefficient) in order to guarantee that the particle 1 passes through the passage opening 3 in the area of the standing flap 5 in a smooth manner without jamming.

Apart from that, reference is made to the above explanations concerning a classification according to the particle width b with the help of a screen deck 11 and passage openings 3 with a three dimensional classification effect.

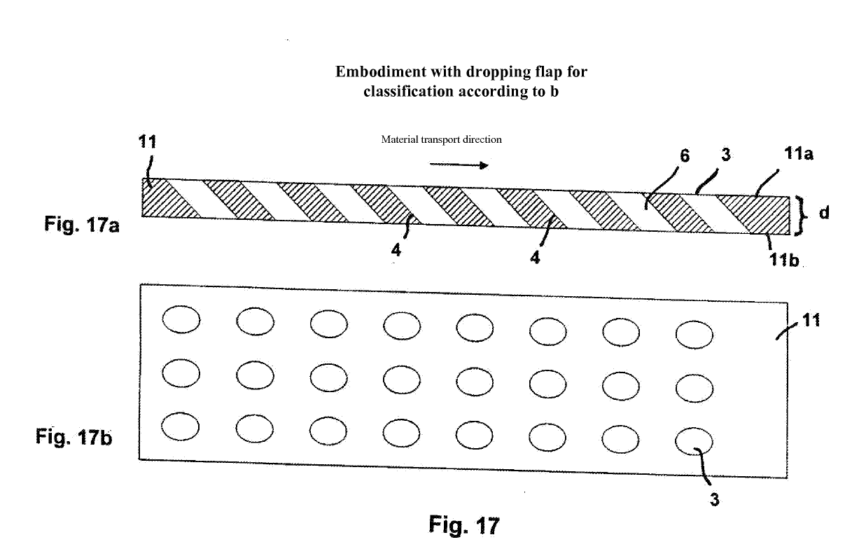

FIG. 17 shows an execution of a screen deck 11 in a sectional view (FIG. 17a) in a top view with circular or elliptical passage openings 3 and integrated dropping flaps 4 and opening conduits 6 pointing in the material transport direction, whereby here again the screen deck 11 has coplanar upper and lower sides 11a and 11b and a thickness d corresponding to the classification task according to the width b. Apart from that, reference is made to the above explanations regarding classification according to the width b as a main dimension of the particle and, in particular, the importance of a low friction coefficient of the screen deck with regard to the nature of the particle to be classified in order to avoid jamming grains is pointed out.

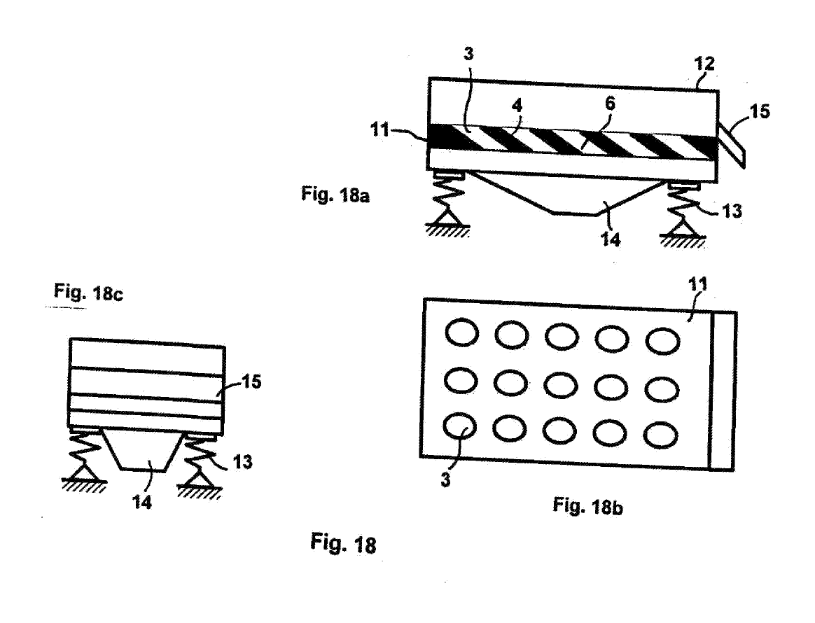

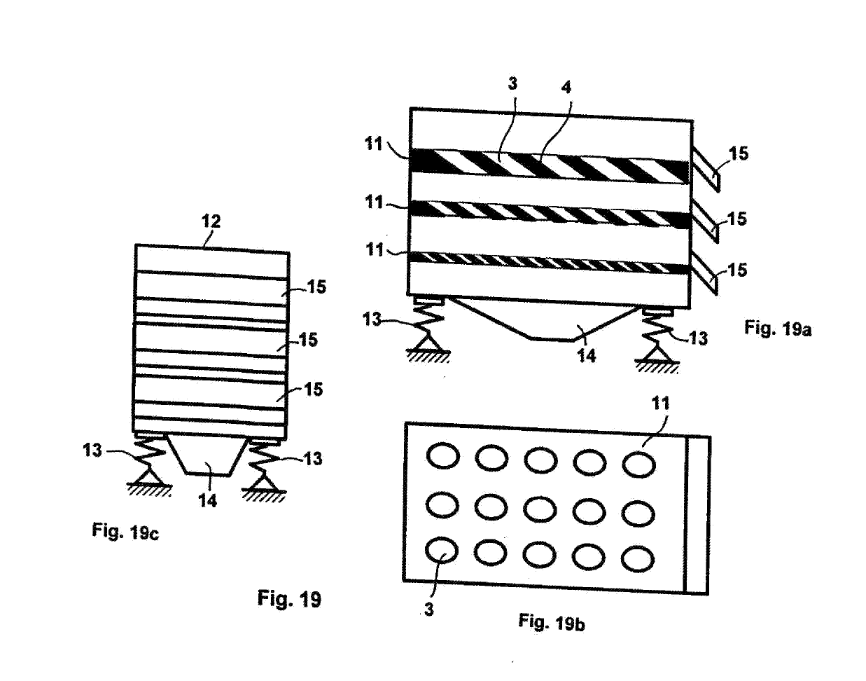

FIG. 18 illustrates a classification machine 16 using a screen deck 11 according to FIG. 17, while on the other hand, FIG. 19 illustrates a fractionated classification according to the width b into three different fractions with three screen decks 11 of various classification sizes for the width b. Apart from that, the above explanations regarding the configuration of such a classification machine 16 apply.

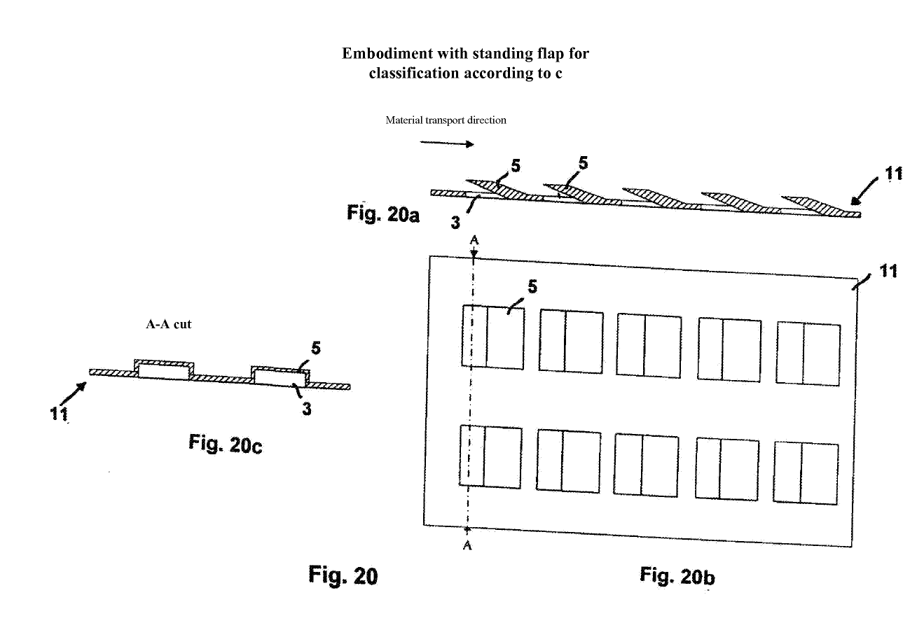

The FIG. 20 with the schematic sectional views of a screen deck 11 in FIG. 20a, a top view in FIG. 20b and a side view (sectional view according to FIG. 20b) in FIG. 20c illustrate a device embodiment for a classification according to the thickness of the particles, again given appropriate agreement of the dimension w_{z} (compare FIG. 9b in this regard). In this case, the dimension w_{z} is the smallest, particularly with regard to the comparable dimensions, i.e., the distances between the standing flaps and the XY plane for a classification according to the length a.

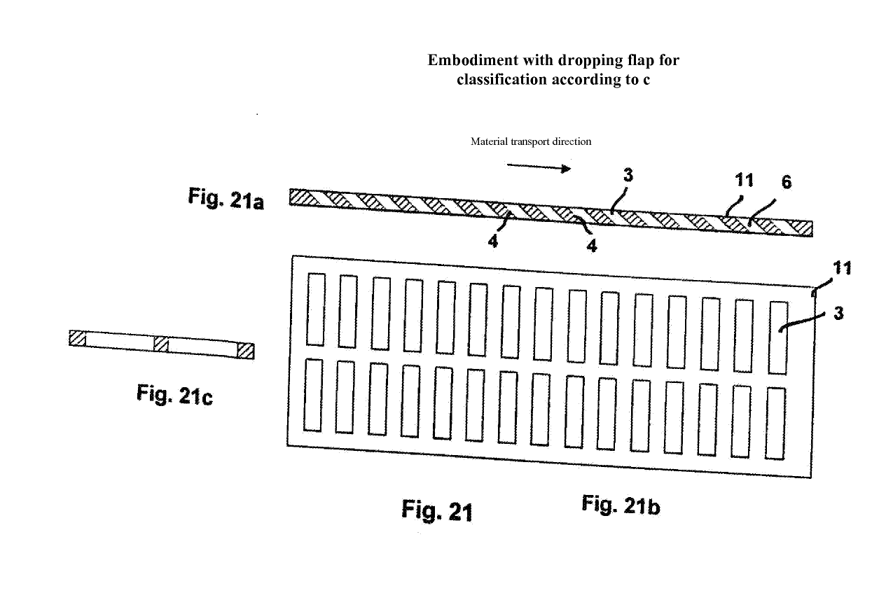

Finally FIG. 21 shows another embodiment using 3D rectangular holes as passage openings 3 with a classification effect for the screen deck (top view: FIG. 21b), here in an execution in which the corresponding dropping flaps 4 are formed by the thickness d of the screen deck 11 and corresponding opening conduits 6 that are inclined in the material transport direction.

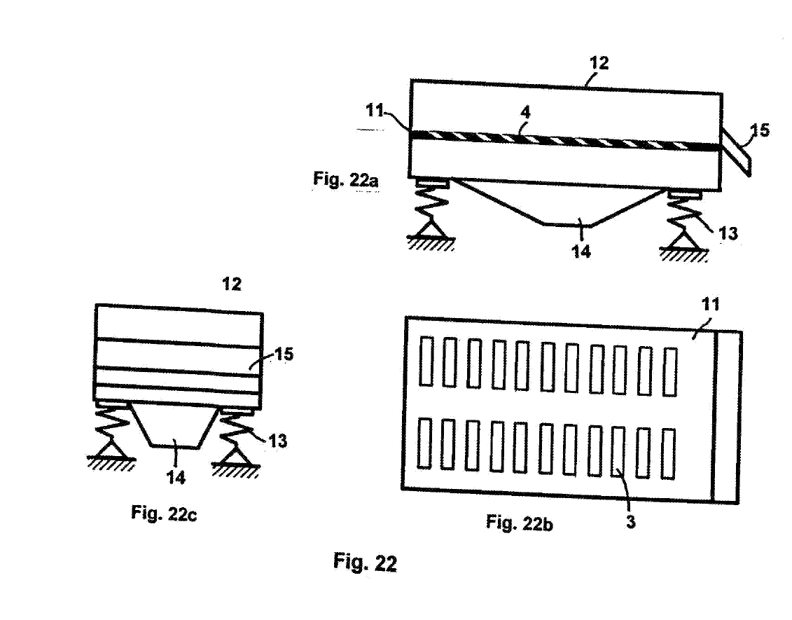

In FIGS. 22a, b and c, FIG. 22 shows a device implementation with a single-deck variant and dropping flaps, comparable to the corresponding figures for the classification parameters b or a.

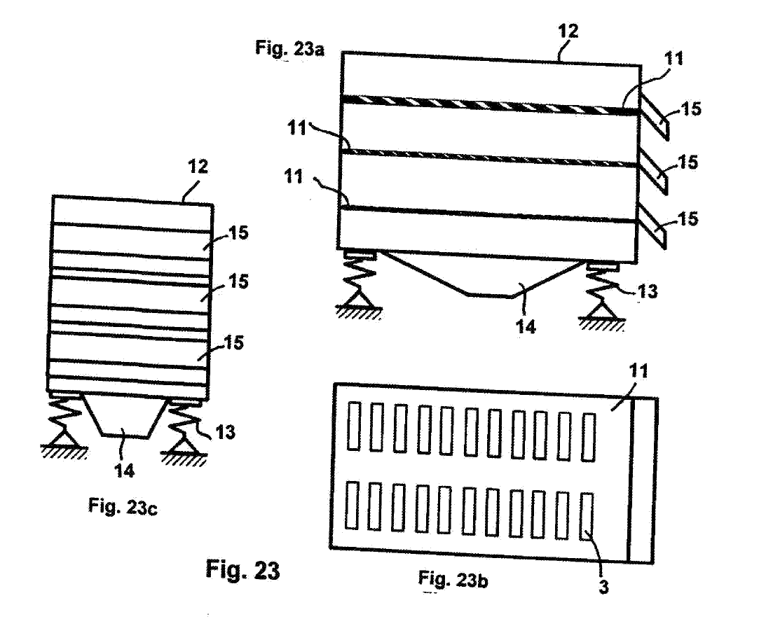

FIG. 23 in turn illustrates a multi-deck sorting machine (three screen decks) for the formation of three fractions of particles sorted according to the thickness using rectangular passage openings 3 that extend in the width direction of the screen deck 11. Apart from that the explanations already given for the reference numbers apply accordingly.

Due to the invention, it is possible, compared to previous two-dimensional and less selective screen geometric forms, through the use of passage openings with a three dimensional classification effect, preferably in designs with standing flaps or dropping flaps, whereby the latter can also be made in a material thickness of a, e.g., screen deck made of polyurethane or other plastic screen deck manufactured by injection moulding or in another manner by casting or mechanically, e.g., by milling, to achieve a selective size classification of particles by a corresponding measurement of a distance between the passage geometric form and the XY plane (classification plane) depending on classification parameters, namely on the basis of the three main dimensions of the particles in space (length, width, thickness), whereby depending on the classification parameters, essentially different friction conditions of the friction pairing particle-screen deck must be met and in the classification according to the length a, a high friction coefficient (static friction coefficient μ≧0.3, preferably μ>0.7) must be guaranteed so that the classification goods remain lying on the corresponding screen deck 11, while in a classification according to the width or thickness of the particles, these pass through the corresponding passage openings 3 with a three dimensional classification effect with the lowest possible friction coefficients of the static friction between the screen deck and particle (μ≦0.3).

Some but not all of the uses of the invention are the classification processes in agriculture, such as during the harvesting and further processing of fruits, vegetables, berries and grains, for seeds, fertilizers, feed, spices, coffee beans, nuts, tobacco, tea, eggs or other animal products, as well as fish, meat or (intermediate) products thereof, as well as by-products or secondary products that arise; in industry, for the cleaning or processing of raw materials such as broken stone, crushed rock, ores, coals, salts, wood materials as well as semi-finished products or intermediate products, natural or synthetic bulk materials or powders such as, for example, lime, cement, fibres, coke, natural graphite, synthetic graphite, plastics as well as their additives, composite materials, ceramic, glass, metal, wood shavings, additives for industrial processes, blasting or polishing agents, screws, nails, coins, gemstones, semi-precious stones, scrap metal, recyclates or other waste streams, bulk materials or powders in the chemical or pharmaceutical industry, such as, for example, washing powders, pigments, fillings for reactors, catalysts, medical or cosmetic active ingredients and auxiliary agents or tablets.

1. A method for the selective classification of particles according to the size thereof, comprising determining a maximum main dimension length (a), width (b), thickness (c)) of the particle geometric form, and classifying using passage openings with a three dimensional classification effect in a screening structure.

2. The method according to claim 1, wherein classifying the particles place according to one of the maximum main dimensions length (a) or width (b) or thickness (c).

3. The method according to claim 1, wherein classifying the particles in at least one vibrating, non-vibrating, inclined, classification plane or the classification plane has rectangular, square, elliptical, or circular, passage openings and particles are moved along an inclined plane in the area of the passage openings with a three dimensional classification effect.

4. The method according to claim 1, the screening structure, at least in the area of the passage openings, has a predetermined friction coefficient, particularly a static friction coefficient (μ), in dependence on the main dimension to be classified as well as on the material to be classified.

5. The method according to claim 1, wherein of classifying the particles according to the main dimension length (a), wherein the particles that are larger than the passage openings remain on a screen deck of the screening structure.

6. The method according to claim 5, further including a classification lining of the screening structure has, at least in the area of the passage openings, an increased static friction coefficient, particularly a static friction coefficient μ≧0.3, particularly μ≧0.7.

7. The method according to claim 1, further including a classification lining of the screening structure has, for a classification according to the main dimensions maximum width (b) or maximum thickness (c), at least in the area of the passage openings, a reduced static friction coefficient, particularly a static friction coefficient μ≦0.3.

8. The method according to claim 1, wherein a fractionation of the particles into size fractions of these maximum main dimensions (a; b; c) takes place and a plurality of fractions of particles classified according to the same main dimension takes place essentially simultaneously and/or spatially adjacent or separated in time and space in connection with a classification according to a maximum main dimension (a; b; c).

9. A device for selective classification of particles of a feedstock according to the size thereof, determined by a maximum main dimension of the same, particularly for carrying out the method according claim 1, with a classification device that has a screening structure with passage openings with a three dimensional classification effect.

10. The device according to claim 9, wherein the passage openings have standing flaps or standing conduits that protrude from a base of a classification plane on the one hand or on the other hand, dropping flaps or dropping conduits that protrude from the base of the classification plane.

11. The device according to claim 9, wherein the standing or dropping flaps are arranged opposite to a transport direction of the particles along the classification plane that for a classification according to the main dimension length (a).

12. The device according to claim 9, wherein standing or dropping conduits limited by the standing or dropping flaps of the passage openings are arranged oriented in correspondence with a transport direction of the particles or opposite to the same along the classification plane for a classification according to the main dimension width (b).

13. The device according claim 9, wherein standing or dropping conduits, limited by the standing or dropping flaps, of the passage openings are arranged in correspondence with or opposite to a transport direction of the particles along the classification plane for a classification according to the main dimension thickness (c).

14. The device according to claim 9, wherein the passage openings with the three-dimensional classification effect are arranged between an essentially level particle feed side of the screening structure, particularly the screen deck, and an essentially level withdrawal side of the same with inclined opening conduits.

15. The device according to claim 9, wherein the classification device has at least a level screen deck with an opening geometric form with 3D rectangular hole, 3D square hole, 3D round hole or 3D elliptical hole, particularly a combination of round, elliptical, rectangular or square opening of a base of the classification plane with a dropping flap or a dropping conduit or a standing flap or a standing conduit.

16. The device according to claim 9, wherein a shared housing, a plurality of classification devices, particularly screen decks for forming different fractions with the classification according to a common, maximum main dimension (a; b; c), are arranged and each is connected to an associated discharge device for conveying the classified particle fraction away.

17. The device according to claim 9, wherein the classification device is a screen device having a circular, elliptical, linear or planar vibrator, or a stationary classification plane is formed by a screen device, particularly a screen deck arranged at an incline.

18. The device according to claim 9, further including a screen deck having coplanar upper and lower sides, and passage openings with a three dimensional classification effect are formed by inclined opening conduits that extend between the upper and lower sides, wherein a thickness (d) of the screen deck is defined in dependence on the type of the maximum main dimension (a; b; c), and the opening conduits simultaneously form dropping flaps.
